(19) United States
(12) Patent Application Publication
(10) Pub. No.: US 2013/0170829 A1
(43) Pub. Date: Jul. 4, 2013

(54) Optical Coherent Receiver Optimization

(71) Applicant: Sunil Kumar Singh Khatana, Sunnyvale, CA (US)

(72) Inventor: Sunil Kumar Singh Khatana, Sunnyvale, CA (US)

(73) Assignee: OPNEXT SUBSYSTEMS, INC., San Jose, CA (US)

(21) Appl. No.: 13/341,333

(22) Filed: Dec. 30, 2011

(51) Int. Cl. H04B 10/08; H04B 10/06

(52) U.S. Cl. 398/27; 398/25

(57) ABSTRACT

Coherent optical receiver performance is optimized and made adaptable to changing optical channel conditions by providing feedback loops to adjust receiver parameters based on measured receiver performance.

### TECHNICAL FIELD

The disclosure is generally related to optimizing the performance of optical coherent receivers used in high-speed communications.

### BACKGROUND

Next-generation long-haul, fiber-optic communications systems are being designed to operate at 100 gigabits per second over distances of 1,000 kilometers or more. Coherent optical receivers have been proposed as an alternative to conventional direct detection receivers for high-speed, fiber-optic systems because, among other reasons, they recover the phase of optical electric fields. When in-phase (I) and quadrature (Q) components of an optical signal are known, exact equalization of linear channel impairments is possible in principle and the effects of nonlinear impairments may be reduced.

Coherent optical receivers have many components devoted to different signal recovery and demodulation tasks. Such components include a laser local oscillator (LO), hybrid mixer, photodetectors, analog-to-digital converters, and timing recovery, frequency offset correction, chromatic dispersion compensation, adaptive equalization, and carrier phase estimation subsystems. Many possible static adjustments may be made to each of these components to optimize receiver performance for an assumed set of operating conditions.

In real-world communication applications, however, transmitter, receiver and optical link conditions may change at any time. Even stable systems operating in protected environments present changing communications conditions after transients such as power cycles or the beginning of high-data-rate communications over a previously idle link. One-time or static adjustments to the components of a complicated coherent optical receiver do not provide optimum performance as conditions change. Thus, what is needed is a way to maintain optimum receiver performance under changing conditions.

### SUMMARY

The technologies described herein relate to optimizing the performance of optical coherent receivers used in high-speed communications. For example, coherent optical receiver performance can be optimized and made adaptable to changing optical channel conditions by providing feedback loops to adjust receiver parameters based on measured receiver performance.

One aspect of the subject matter described in this specification can be implemented in methods that include receiving an optical signal at a coherent optical receiver, and mixing, by an optical hybrid mixer of the coherent optical receiver, the received optical signal with a local oscillator signal to generate a mixed optical signal. The methods further included converting, by a photodetector of the coherent optical receiver, the mixed optical signal to an electrical signal, and converting, by an analog-to-digital converter of a digital modem associated with the coherent optical receiver, the electrical signal to digital data. Furthermore, the methods included estimating, by a carrier phase estimator of the digital modem, the phase of the optical signal by averaging the digital data with an adjustable number of taps of the carrier phase estimator. Also, the methods include determining, by a forward error correction estimator of the digital modem, receiver performance statistics based on the averaged digital data. In addition, the methods include automatically adjusting, by a controller of the digital modem, the number of taps of the carrier phase estimator in response to the determined receiver performance statistics.

The foregoing and other implementations can each optionally include one or more of the following features, alone or in combination. In some implementations, the receiver performance statistics can include bit-error rate. In other implementations, the receiver performance statistics can include Q2. Further, automatically adjusting the number of taps can include iteratively increasing or decreasing the number of taps used by the carrier phase estimator to average the digital data until the determined receiver performance statistics indicate optimum receiver performance.

In some implementations, the methods also can include equalizing the digital data by an adaptive equalizer of the digital modem, where the adaptive equalizer has an adjustable gain. Further, the methods can include determining, by the forward error correction estimator of the digital modem, additional receiver performance statistics based on the equalized digital data, and automatically adjusting, by a controller of the digital modem, the gain in the adaptive equalizer in response to the determined additional receiver performance statistics. For instance, automatically adjusting the gain can include iteratively increasing or decreasing the gain of the adaptive equalizer until the additional determined receiver performance statistics indicate optimum receiver performance.

According to another aspect, the described subject matter can also be implemented in a coherent optical receiver including an optical front end that receives an optical signal including a carrier signal modulated by a data signal, and converts the received optical signal to an electrical signal corresponding to the data signal. The coherent optical receiver further includes a digital modem coupled with the optical front end. The digital modem includes an analog-to-digital converter that converts the electrical signal to digital data, a carrier phase estimator that estimates the phase of the optical signal by averaging the digital data with an adjustable number of taps of the carrier phase estimator, a forward error correction estimator that determines error statistics based on the averaged digital data, and a controller that automatically adjusts the number of taps in the carrier phase estimator in response to the error statistics determined by the forward error correction estimator.

The foregoing and other implementations can each optionally include one or more of the following features, alone or in combination. In some implementations, the controller comprises a dedicated electronic circuit. In other implementations, the controller comprises a data processing apparatus.

In some implementations, the digital modem also can include an adaptive equalizer that equalizes the digital data with an adjustable gain, and the forward error correction estimator further can determine additional error statistics based on the equalized digital data. Additionally, the digital modem further can include a second controller that automatically adjusts the gain of the adaptive equalizer in response to the additional error statistics determined by the forward error correction estimator.

According to another aspect, the described subject matter can also be implemented in methods including receiving an optical signal at a coherent optical receiver, and mixing, by an optical hybrid mixer of the coherent optical receiver, the received optical signal with a local oscillator signal to generate a mixed optical signal. The methods further include converting, by a photodetector of the coherent optical receiver, the mixed optical signal to an electrical signal, and converting, by an analog-to-digital converter of a digital modem associated with the coherent optical receiver, the electrical signal to digital data. Furthermore, the methods include equalizing the digital data by an adaptive equalizer of the digital modem, where the adaptive equalizer has an adjustable gain. Also, the methods include determining, by a forward error correction estimator of the digital modem, receiver performance statistics based on the equalized digital data. In addition, the methods include automatically adjusting, by a controller of the digital modem, the gain in the adaptive equalizer in response to the determined receiver performance statistics.

The foregoing and other implementations can each optionally include one or more of the following features, alone or in combination. In some implementations, the receiver performance statistics can include bit-error rate. In other implementations, the receiver performance statistics can include Q2. Also, automatically adjusting the gain can include iteratively increasing or decreasing the gain of the adaptive equalizer until the determined receiver performance statistics indicate optimum receiver performance.

According to another aspect, the described subject matter can also be implemented in a coherent optical receiver including an optical an optical front end that receives an optical signal including a carrier signal modulated by a data signal, and converts the received optical signal to an electrical signal corresponding to the data signal. The coherent optical receiver also includes a digital modem coupled with the optical front end. The digital modem includes an analog-to-digital converter that converts the electrical signal to digital data, an adaptive equalizer having an adjustable gain, such that the adaptive equalizer equalizes the digital data, a forward error correction estimator that determines error statistics based on the equalized digital data, and a controller that automatically adjusts the gain of the adaptive equalizer in response to the error statistics determined by the forward error correction estimator.

The foregoing and other implementations can each optionally include one or more of the following features, alone or in combination. In some implementations, the controller comprises a dedicated electronic circuit. In other implementations, the controller comprises a data processing apparatus.

According to another aspect, the described subject matter can also be implemented in methods including receiving an optical signal at a coherent optical receiver, and mixing, by an optical hybrid mixer of the coherent optical receiver, the received optical signal with a local oscillator signal to generate a mixed optical signal. The local oscillator signal is generated by a tunable laser of the optical hybrid mixer. The methods further include converting, by a photodetector of the coherent optical receiver, the mixed optical signal to an electrical signal, and converting, by an analog-to-digital converter of a digital modem associated with the coherent optical receiver, the electrical signal to digital data. Furthermore, the methods include processing, by a frequency offset estimator of the digital modem, the digital data to obtain a frequency offset between the local oscillator signal and the received optical signal. Additionally, the methods include automatically tuning, by a controller of the coherent optical receiver, the tunable laser of the optical hybrid mixer to minimize the frequency offset obtained by the frequency offset correction estimator.

According to another aspect, the described subject matter can also be implemented in a coherent optical receiver including an optical front end that receives an optical signal including a carrier signal modulated by a data signal. The optical front end includes an optical hybrid mixer that mixes the received optical signal with a local oscillator signal to extract the data signal from the optical signal, and a photodetector to convert the extracted data signal to an electrical signal corresponding to the data signal. The coherent optical receiver further includes a digital modem coupled with the optical front end. The digital modem includes an analog-to-digital converter that converts the electrical signal to digital data, and a frequency offset estimator that processes the digital data to obtain a frequency offset between the local oscillator signal and the received optical signal. Additionally, the coherent optical receiver includes a controller that automatically adjusts a frequency of the local oscillator signal to minimize the frequency offset obtained by the frequency offset estimator.

The foregoing and other implementations can each optionally include one or more of the following features, alone or in combination. In some implementations, the controller comprises a dedicated electronic circuit. In other implementations, the controller comprises a data processing apparatus.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A and 1B are graphs showing optical coherent receiver passband and signal spectrum for nonzero and zero LO frequency offset, respectively.

FIG. 2 is a block diagram of a coherent optical receiver with a controller that adjusts LO laser frequency in response to a frequency error estimate from a frequency offset correction block of a digital modem.

FIG. 3 is a block diagram of a carrier phase estimation (CPE) unit in a digital receiver.

FIG. 4 shows graphs of Q² (dB) versus CPE tap length in two different situations: one where optical nonlinearities are a significant source of error and one where they aren't.

FIG. 5 is a block diagram of a coherent optical receiver with a controller that adjusts CPE averaging time and shape in response to bit-error-rate statistics from a forward error correction block of a digital modem.

FIG. 6 is a block diagram of a coherent optical receiver with a step size controller that adjusts an adaptive equalizer in response to bit-error-rate statistics from a forward error correction block of a digital modem.

### DETAILED DESCRIPTION

### Introduction

The systems and methods for optical coherent receiver optimization described below keep receivers operating at maximum performance even as signal conditions change. The systems and methods are based on feedback control. Measured downstream performance, e.g. frequency error, bit-error-rate, Q², etc, is used to create error signals that drive controllers for upstream receiver components.

Feedback control systems and methods are described for laser frequency tuning, carrier phase estimation optimization and adaptive equalizer optimization.

### Laser Frequency Tuning

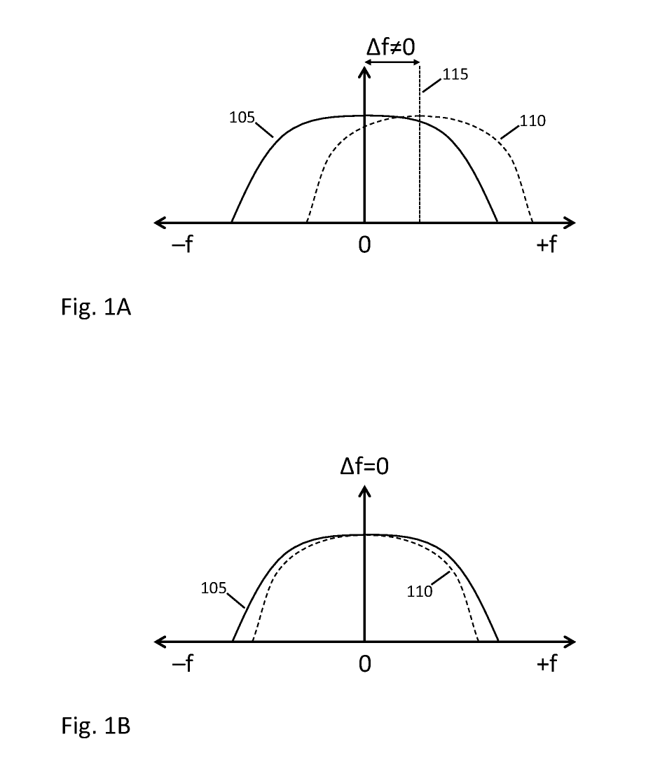

When an offset exists between LO and received signal frequencies, part of the signal spectrum may be attenuated. If a receiver passband is made wider to accommodate potential LO offsets, then noise is amplified. FIGS. 1A and 1B illustrate the situation.

FIGS. 1A and 1B are graphs showing optical coherent receiver passband and signal spectrum for nonzero and zero LO frequency offset, respectively. In FIGS. 1A and 1B, solid line 105 represents a receiver passband while dashed line 110 represents a received signal spectrum. The receiver passband is centered at zero frequency. In FIG. 1A, dashed line 115 represents the center of received signal spectrum 110. The center of the spectrum is offset from the receiver passband by an amount Δf, as shown in the figure. Part of the received signal is outside the passband and is therefore attenuated.

In FIG. 1B the offset between LO and received signal frequencies, Δf shown in FIG. 1A, has been eliminated or made negligible. The received spectrum fits closely within the receiver passband. If the receiver passband were made significantly wider than the received signal, then excess noise would be unnecessarily passed to later receiver stages and amplified.

LO frequency offset can be reduced or eliminated by using the frequency offset correction block in a digital receiver to provide a frequency error signal for an LO controller. Frequency offset correction is a function that is performed digitally in a typical coherent optical receiver modem. The frequency offset correction system not only corrects frequency offset, but may also provide an estimate of how far apart signal and LO frequencies are. Even though digital frequency offset correction works well, better performance is achieved when LO frequency offset is minimized in the first place.

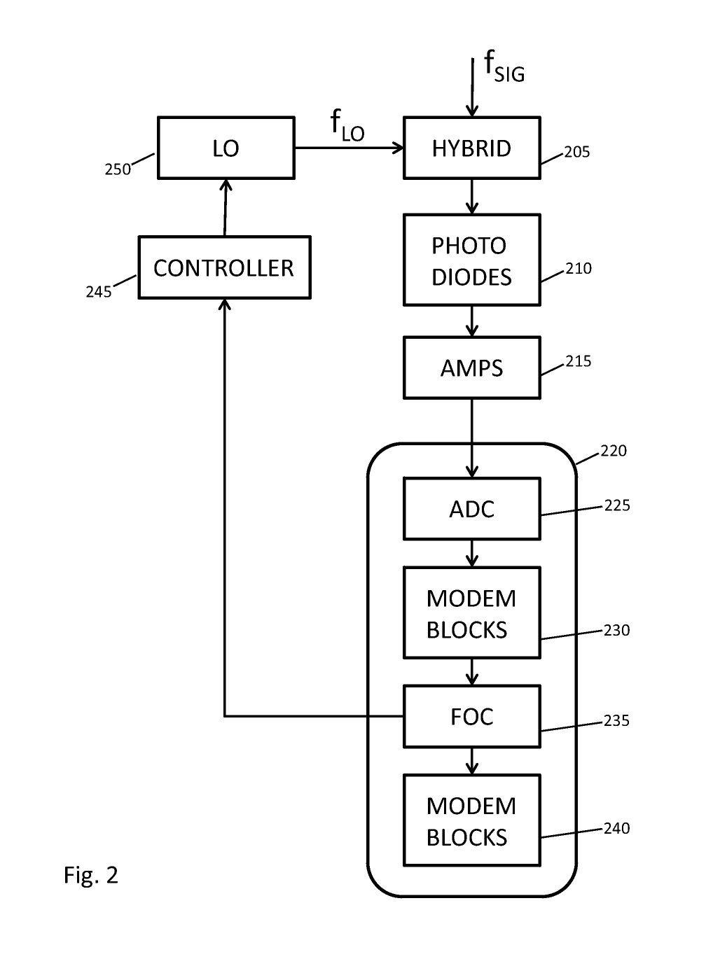

FIG. 2 is a block diagram of a coherent optical receiver with a controller that adjusts LO laser frequency in response to a frequency error estimate from a frequency offset correction block of a digital modem. In FIG. 2, a received signal is mixed with a local oscillator signal in hybrid 205. The receiver also includes photodiodes 210, amplifiers 215 and modem 220. Modem 220 includes analog-to-digital converters 225, frequency offset correction block 235, and other modem blocks 230 and 240. These other blocks represent functions such as chromatic dispersion correction and adaptive equalization.

Controller 245 receives a frequency error signal from FOC block 235 and uses the signal to generate a control signal that adjusts the frequency of LO laser 250. If the block reports that the LO laser frequency is greater than the signal frequency by a certain amount, for example, then the controller reduces the laser frequency by the same amount. In this way the LO frequency is placed under feedback control and the situation of FIG. 1B, LO and signal spectra aligned, prevails.

### Carrier Phase Estimator Optimization

The optimum number of carrier phase estimator taps, corresponding to averaging time, and the optimum shape of the averaging filter depend on whether or not nonlinearities are present in an optical channel. Longer averaging suppresses noise, but too long averaging is detrimental in the presence of nonlinearities such as cross phase modulation. The feedback loop described below uses error statistics from the forward error correction (FEC) block of a digital receiver as an error signal for a controller that makes dynamic adjustments to the number of taps used in a carrier phase estimator and the shape of the CPE filter.

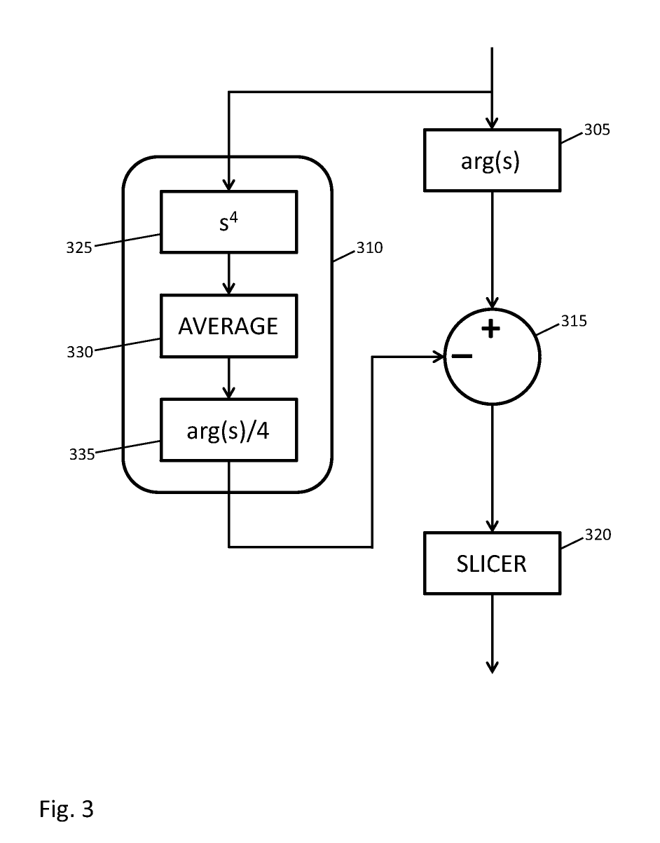

FIG. 3 is a block diagram of an example of a carrier phase estimation (CPE) unit in a digital receiver. A CPE performs digital operations on a stream of complex numbers to determine their average phase. The phase of each symbol in an NRZ symbol stream is determined by comparison to the average phase. In FIG. 3, the argument of each incoming complex number in a stream of complex numbers is computed in block 305. The average phase of complex numbers in the stream is computed in block 310 which includes the operations of raising to the fourth power (325), averaging the result (330), and computing the argument of the resulting average and dividing by four. Here, fourth power and argument divided by four are appropriate for QPSK signals. (In general, if the received signal constellation consists of N symbols equidistant from the origin and equally spaced, then CPE could be based on raising the complex number representation of those symbols to the Nth power and dividing the argument of the average by N.) The phase of each symbol is compared to the average by comparator 315; the result is sent to slicer 320 which makes the final symbol by symbol identification.

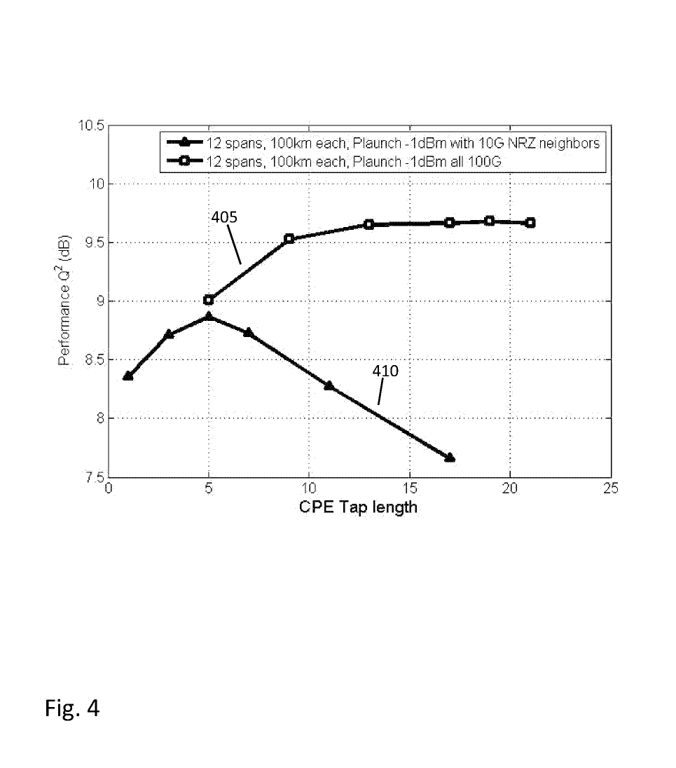

FIG. 4 shows graphs of Q² (dB) versus CPE tap length in two different situations: one where optical nonlinearities are a significant source of CPE error and one where they aren't.

In FIG. 4, line 405 connects data points representing Q² measurements as a function of CPE tap length for a transmission system having 12 spans of 100 Gb/s channels with a launch power of −1 dBm. More CPE taps provide better Q² performance with diminishing returns for more than around 10 or 12 taps.

Line 410 connects data points representing Q² measurements as a function of CPE tap length for a transmission system having 12 100 Gb/s channels with a launch power of −1 dBm. In this case, however, nearby 10 Gb/s NRZ channels cause cross phase modulation (XPM). Now the optimum tap length is 5 as that number of taps gives the best Q² performance. More taps do not improve Q² because of the effect of nonlinearities such as XPM.

It is not always possible to predict whether or not XPM from nearby optical channels will be a factor in a communications system. For example, if nearby channels cease transmission, then the number of CPE taps should be increased to take advantage of additional averaging. On the other hand, if nearby channels begin transmission after a period of inactivity, then the number of CPE taps should be adjusted to achieve optimum performance. Thus the behavior exhibited in FIG. 4 suggests that a feedback arrangement could be used to adjust the number of CPE taps in response to changing conditions. The error signal in such a feedback system may be provided by the forward error correction (FEC) block in a digital receiver.

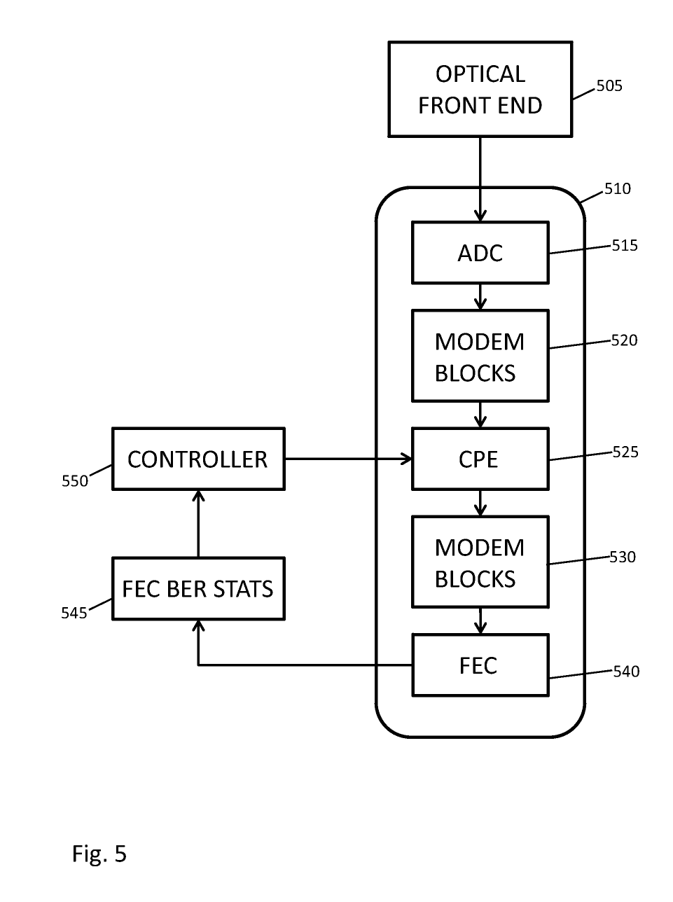

FIG. 5 is a block diagram of a coherent optical receiver with a controller that adjusts CPE averaging time and shape in response to bit-error-rate statistics from a forward error correction block of a digital modem. In FIG. 5, optical front end 505 includes an optical hybrid mixer, photodetectors and amplifiers. Digital receiver 510 includes analog-to-digital converters 515, modem blocks 520 and 530 which may include function such as chromatic dispersion compensation or adaptive equalization, carrier phase estimation block 525, and forward error correction block 540.

Controller 550 uses FEC bit-error-rate statistics 545 as an error signal when adjusting the number of taps or the filter shape or both in CPE block 525. For example, if the bit-error-rate, Q², or other performance statistics indicate that performance is decreasing over time, then the controller may reconfigure CPE block 525 to use more taps. If that causes the performance to decrease even more, then the controller may reconfigure CPE block 525 to use fewer taps.

### Adaptive Equalizer Optimization

The gain or step size of an adaptive equalizer (AEQ) affects adaptation time and noise suppression characteristics. A large step size leads to quick adaptation, but worse long-term noise performance. A small step size leads to slow adaptation, but better long-term noise performance. In most adaptive equalizers a fixed step size is chosen as a compromise between the benefits of larger or smaller step sizes. This compromise does not provide the best possible adaptive equalizer performance in either the short or long term. For example, just after power up, a large step size is desirable to find approximate AEQ taps quickly. At later times a smaller step size is desirable to reduce noise.

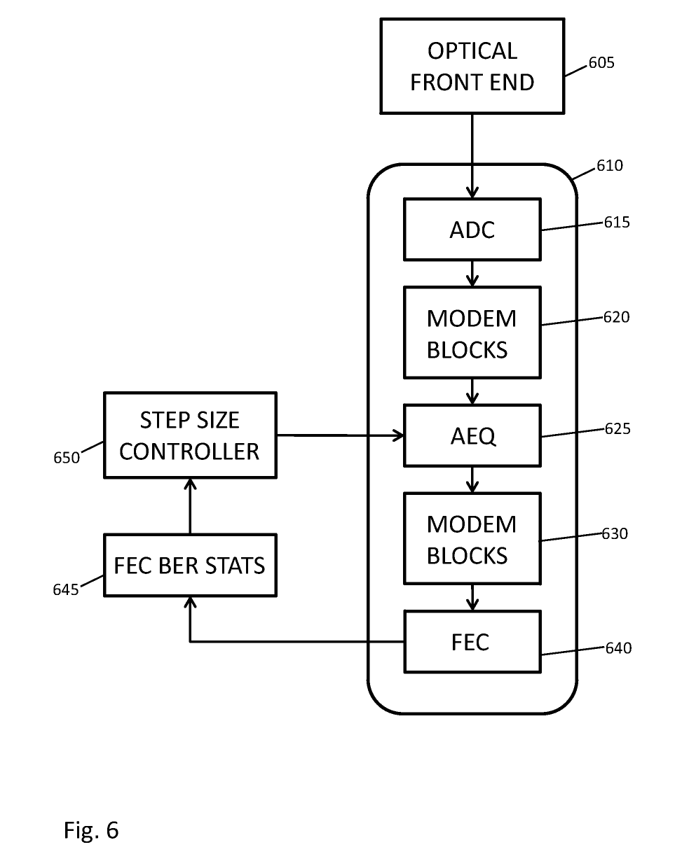

The system described below uses FEC statistics, e.g. bit-error-rate, Q², etc, as a feedback signal to a controller that adjusts the AEQ step size or gain dynamically. FIG. 6 is a block diagram of a coherent optical receiver with a step size controller that adjusts an adaptive equalizer in response to bit-error-rate statistics from a forward error correction block of a digital modem.

In FIG. 6, optical front end 605 includes an optical hybrid mixer, photodetectors and amplifiers. Digital receiver 610 includes analog-to-digital converters 615, modem blocks 620 and 630 which may include function such as chromatic dispersion compensation or carrier phase estimation, adaptive equalizer block 625, and forward error correction block 640.

AEQ step size controller 650 uses FEC bit-error-rate statistics 645 as an error signal when adjusting the step size of AEQ 625. For example, the step size controller may reduce the step size and then monitor the FEC statistics to see if the bit-error-rate improves or gets worse. Depending on the result the step size may be increased or decreased to keep the bit-error-rate as low as possible.

### CONCLUSION

Three systems and methods for receiver optimization have been described. In each case downstream receiver performance statistics are used as an error signal for a controller that adjusts an upstream receiver component. Controllers, such as 245, 550 or 650, may be implemented in dedicated hardware, e.g. discrete components, application specific integrated circuits, field programmable gate arrays, etc., or in software that is encoded on computer storage medium and is executed by a data processing apparatus such as a microcontroller, microprocessor or the like.

In general, any of the technologies disclosed in this specification, including the systems and processes used to optimize optical coherent receivers as described above, can be implemented in computer hardware or software, or a combination of both. For example, in some embodiments, controllers, such as 245, 550 or 650, can be installed in a computer that is communicatively coupled to one or more optical coherent receivers and configured to control the optical coherent receivers. Feedback analysis performed by the controllers, such as 245, 550 or 650, can be implemented in computer programs using standard programming techniques following the methods described herein. Program code is applied to input data (e.g., error statistics) to perform the functions described herein and generate output information (e.g., control information). The output information can be applied to components of the one or more optical coherent receivers, and optionally to one or more output devices such as a display monitor. Each program may be implemented in a high level procedural or object oriented programming language to communicate with a computer system. However, the programs can be implemented in assembly or machine language, if desired. In any case, the language can be a compiled or interpreted language. Moreover, the program can run on dedicated integrated circuits preprogrammed for that purpose.

Each such computer program is preferably stored on a storage medium or device (e.g., ROM or magnetic storage device) readable by a general or special purpose programmable computer, for configuring and operating the computer when the storage media or device is read by the computer to perform the procedures described herein. The computer program can also reside in cache or main memory during program execution. The optimization methods described in this specification can also be implemented as a computer-readable storage medium, configured with a computer program, where the storage medium so configured causes a computer to operate in a specific and predefined manner to perform the functions described herein.

The above description of the disclosed embodiments is provided to enable any person skilled in the art to make or use the disclosure. Various modifications to these embodiments will be readily apparent to those skilled in the art, and the principles defined herein may be applied to other embodiments without departing from the scope of the disclosure. Thus, the disclosure is not intended to be limited to the embodiments shown herein but is to be accorded the widest scope consistent with the principles and novel features disclosed herein.

What is claimed is:

1. A method comprising:
receiving an optical signal at a coherent optical receiver;
mixing, by an optical hybrid mixer of the coherent optical receiver, the received optical signal with a local oscillator signal to generate a mixed optical signal;
converting, by a photodetector of the coherent optical receiver, the mixed optical signal to an electrical signal;
converting, by an analog-to-digital converter of a digital modem associated with the coherent optical receiver, the electrical signal to digital data;
estimating, by a carrier phase estimator of the digital modem, the phase of the optical signal by averaging the digital data with an adjustable number of taps of the carrier phase estimator;
determining, by a forward error correction estimator of the digital modem, receiver performance statistics based on the averaged digital data; and
automatically adjusting, by a controller of the digital modem, the number of taps of the carrier phase estimator in response to the determined receiver performance statistics.

2. The method of claim 1, wherein the receiver performance statistics include bit-error rate.

3. The method of claim 1, wherein the receiver performance statistics include Q².

4. The method of claim 1, wherein the automatically adjusting of the number of taps includes iteratively increasing or decreasing the number of taps used by the carrier phase estimator to average the digital data until the determined receiver performance statistics indicate optimum receiver performance.

5. The method of claim 1, further comprising:
equalizing the digital data by an adaptive equalizer of the digital modem, the adaptive equalizer having an adjustable gain;
determining, by the forward error correction estimator of the digital modem, additional receiver performance statistics based on the equalized digital data; and
automatically adjusting, by a controller of the digital modem, the gain in the adaptive equalizer in response to the determined additional receiver performance statistics.

6. The method of claim 5, wherein the automatically adjusting the gain includes iteratively increasing or decreasing the gain of the adaptive equalizer until the additional determined receiver performance statistics indicate optimum receiver performance.

7. A coherent optical receiver comprising:
an optical front end that receives an optical signal including a carrier signal modulated by a data signal, and converts the received optical signal to an electrical signal corresponding to the data signal; and
a digital modem coupled with the optical front end, the digital modem including
an analog-to-digital converter that converts the electrical signal to digital data,
a carrier phase estimator that estimates the phase of the optical signal by averaging the digital data with an adjustable number of taps of the carrier phase estimator,
a forward error correction estimator that determines error statistics based on the averaged digital data, and
a controller that automatically adjusts the number of taps in the carrier phase estimator in response to the error statistics determined by the forward error correction estimator.

8. The receiver of claim 7, wherein the controller comprises a dedicated electronic circuit.

9. The receiver of claim 7, wherein the controller comprises a data processing apparatus.

10. The receiver of claim 7, wherein
the digital modem further comprises an adaptive equalizer that equalizes the digital data with an adjustable gain,
the forward error correction estimator further determines additional error statistics based on the equalized digital data, and
the digital modem further comprises a second controller that automatically adjusts the gain of the adaptive equalizer in response to the additional error statistics determined by the forward error correction estimator.

11. A method for setting adaptive equalizer gain in a coherent optical receiver comprising:
receiving an optical signal at a coherent optical receiver;
mixing, by an optical hybrid mixer of the coherent optical receiver, the received optical signal with a local oscillator signal to generate a mixed optical signal;
converting, by a photodetector of the coherent optical receiver, the mixed optical signal to an electrical signal;
converting, by an analog-to-digital converter of a digital modem associated with the coherent optical receiver, the electrical signal to digital data;
equalizing the digital data by an adaptive equalizer of the digital modem, the adaptive equalizer having an adjustable gain;
determining, by a forward error correction estimator of the digital modem, receiver performance statistics based on the equalized digital data; and
automatically adjusting, by a controller of the digital modem, the gain in the adaptive equalizer in response to the determined receiver performance statistics.

12. The method of claim 11, wherein the receiver performance statistics include bit-error rate.

13. The method of claim 11, wherein the receiver performance statistics include Q².

14. The method of claim 11, wherein the automatically adjusting the gain includes iteratively increasing or decreasing the gain of the adaptive equalizer until the determined receiver performance statistics indicate optimum receiver performance.

15. A coherent optical receiver comprising:
an optical front end that receives an optical signal including a carrier signal modulated by a data signal, and converts the received optical signal to an electrical signal corresponding to the data signal; and
a digital modem coupled with the optical front end, the digital modem including
an analog-to-digital converter that converts the electrical signal to digital data,
an adaptive equalizer having an adjustable gain, such that the adaptive equalizer equalizes the digital data,
a forward error correction estimator that determines error statistics based on the equalized digital data, and
a controller that automatically adjusts the gain of the adaptive equalizer in response to the error statistics determined by the forward error correction estimator.

16. The receiver of claim 15, wherein the controller comprises a dedicated electronic circuit.

17. The receiver of claim 15, wherein the controller comprises a data processing apparatus.

18. A method for controlling local oscillator frequency in a coherent optical receiver comprising:
receiving an optical signal at a coherent optical receiver;
mixing, by an optical hybrid mixer of the coherent optical receiver, the received optical signal with a local oscillator signal to generate a mixed optical signal, where the local oscillator signal is generated by a tunable laser of the optical hybrid mixer;
converting, by a photodetector of the coherent optical receiver, the mixed optical signal to an electrical signal;
converting, by an analog-to-digital converter of a digital modem associated with the coherent optical receiver, the electrical signal to digital data;
processing, by a frequency offset estimator of the digital modem, the digital data to obtain a frequency offset between the local oscillator signal and the received optical signal; and
automatically tuning, by a controller of the coherent optical receiver, the tunable laser of the optical hybrid mixer to minimize the frequency offset obtained by the frequency offset correction estimator.

19. A coherent optical receiver comprising:
an optical front end that receives an optical signal including a carrier signal modulated by a data signal, the optical front end including
an optical hybrid mixer that mixes the received optical signal with a local oscillator signal to extract the data signal from the optical signal, and
a photodetector to convert the extracted data signal to an electrical signal corresponding to the data signal;
a digital modem coupled with the optical front end, the digital modem including
an analog-to-digital converter that converts the electrical signal to digital data, and
a frequency offset estimator that processes the digital data to obtain a frequency offset between the local oscillator signal and the received optical signal; and
a controller that automatically adjusts a frequency of the local oscillator signal to minimize the frequency offset obtained by the frequency offset estimator.

20. The receiver of claim 19, wherein the controller comprises a dedicated electronic circuit.

21. The receiver of claim 19, wherein the controller comprises a data processing apparatus.
